(19) United States
(12) Patent Application Publication
(10) Pub. No.: US 2006/0081429 A1
(43) Pub. Date: Apr. 20, 2006

(54) Opening and closing mechanism with damper

(76) Inventors: Hiroshi Ohno, Itabashi Ward (JP); Nobutaka Yajima, Itabashi Ward (JP)

Correspondence Address: WENDEROTH, LIND & PONACK, L.L.P., 2033 K STREET N. W., SUITE 800, WASHINGTON, DC, 20006-1021, US

(21) Appl. No.: 11/237,914

(22) Filed: Sep. 29, 2005

(30) Foreign Application Priority Data
Oct. 18, 2004 (JP) 2004-302984

(51) Int. Cl. F16D 57/00

(52) U.S. Cl. 188/290

(57) ABSTRACT

An object of the present invention is to provide an opening and closing member with damper for use in Western style stool or piano and the like which facilitates an easy control of the rotary damper and easy execution of assembling work, and the hinge members corresponding to the opening and closing member side are adjacently disposed at the same side of the two pieces of the hinge members at the side of the proper member. The rotary damper having a directivity is disposed between the hinge members that face each other, and the mounting member at one side of the rotary damper is tied to the mounting member provided at the hinge member of the proper member, and the mounting member of the other side is tied to the mounting member provided at the hinge member of the opening and closing member. With this arrangement, the opening and closing member is swivellably journalled on the proper member with the rotary damper on its axis of rotation, and the damping power of the rotary damper is applied to the swivelling motion as the opening and closing member swivells with the rotary damper on its axis.

### BACKGROUND OF THE INVENTION

The present invention relates to an opening and closing mechanism with damper for use in Western style stool or piano.

Heretofore, as shown in FIG. 5, in the Western style stool, a pair of hinges 4, 6 is provided at the side of the stool proper member 2, and hinge members 10, 12 are provided at the side of an opening and closing member 8 of a lavatory seat or lavatory lid, and the one hinge member 10 among the hinge members 10, 12 at the side of the opening and closing member 8 is disposed at right side of the hinge 4 of the corresponding stool proper member 2, and the other hinge member 12 is disposed at the left side of the hinge 6 of the side of the corresponding proper member 2, and the opposed hinge 4 and the hinge 10 and the opposed hinge 6 and the hinge 12 are connected by rotary dampers 14, 16 the damping power of which has a direction property of asymmetry type which was disclosed in the official gazette of Japanese Patent Kokai H-10-20167 70.

In FIG. 5, a mounting member 14b with rotation skid face is formed on a cylindrical housing 14a of the rotary damper 14, and the mounting member is tied to a mounting member 4a with rotation skid face that is formed on the side of the hinge member 4. A mounting member 14d with rotation skid face is formed on an axial portion of a rotary member 14c of the rotary damper 14 which projects from the housing 14a, and the mounting member 14d is tied to the mounting member 10a with rotation skid face that is formed on the side of the hinge member 10.

A relationship between the rotary damper 16 and the hinges 6, 12 resembles the mounting structure mentioned above. In FIG. 5, the rotary dampers 14, 16 of right and left hand are disposed on the identical axis.

As shown in FIG. 5, a construction is illustrated wherein the hinge members 10, 12 at the side of the opening and closing member 8 are disposed at sides different from the hinges 4, 6 at the side of the proper member 2, and the hinges 4, 10 and the hinges 6, 12 are of a bilateral symmetry, but the rotary damper 14 disposed between the hinges 4, 10 of the left side and the rotary damper 16 disposed between the hinges 6, 12 of the right side end up with a relationship whose relative rotating direction against the housing of the rotary member is inverted.

Namely, in FIG. 5, when the cover portion (illustration is omitted) of the opening and closing member 8 is swivelled centering with the rotary dampers 14, 16 disposed on coaxial basis in standing up direction from the lid closed condition where it extends to this side in a paper face perpendicular direction, the rotary member 14c of the rotary damper 14 at the left side rotates in clockwise direction relative to the housing 14c, and the rotary member 16c of the rotary damper 16 at the right side rotates in counter clockwise direction relative to the housing 16a.

Accordingly, in case where the rotary damper whose damping power is of asymmetric type is used, it becomes necessary to prepare for two kinds of the rotary dampers whose damping directions for clockwise rotation and for anticlockwise rotation. For this reason, control of component parts becomes complicated, and moreover, mass product effect cannot be expected which were some of the problems. Furthermore, in case of mounting the rotary damper, where mounting position of right and left of two kinds of the rotary dampers is erroneously mistaken, the proper rotation cannot be transmitted to the rotary damper and the desired damping characteristic cannot be obtained which were the problems.

An object of the present invention is to solve the foregoing problems.

### SUMMARY OF THE INVENTION

The present invention has a construction wherein at least two pieces of hinge members are provided at the side of the proper member with a predetermined interval. and at least two pieces of the hinge members are provided at the opening and closing member side in correspondence to each of the hinge member. The hinge member at the opening and closing member side is disposed in opposition to one side of one hinge member among the hinge members at the proper member side and is disposed to one side of the same side with the one hinge member among the other hinge members. A mounting member for the rotary damper is provided at each hinge member at the side of the opening and closing member, and a mounting member for the rotary damper is provided at each hinge member at the opening and closing member side. The rotary damper whose damping power is asymmetric and having the mounting members at both end sides is disposed between the proper side and the opening and closing member side which are disposed in opposition, and the mounting member at one side of the rotary damper is tied to the mounting member provided at the hinge member of the proper member, and the mounting member of the other side of the rotary damper is tied to the mounting member provided on the hinge member of the opening and closing member. In the foregoing construction, the opening and closing member is rockably journalled at the proper member with the rotary damper 30 as a rotation center, and the damping power of the rotary damper is applied to the rocking motion of the opening and closing member with the rotary damper as the pivot.

Furthermore, the present invention is constructed in such a way that the rotary damper is composed of a cylindrical housing and a rotary member whose part is rotatably housed in the housing and being relatively rotatable to the housing, and the mounting member at one end side among the mounting members provided at both end sides of the rotary damper is formed at an end portion of the housing, and the mounting member at the other end side is formed at the end portion of the housing, and the mounting member at the other end side is formed at the end of the rotary member. The shape of the mounting member at one end side of the rotary damper and of the mounting member at the other end side is symmetric.

As the present invention is constructed in such a way, in the opening and closing mechanism with the damper wherein a plurality of dampers having a directivity is used, one kind of the rotary damper may be prepared which is suffice for the object, and the control of component parts is easy and mass production becomes feasible.

Furthermore, in the assembling, there is no apprehension for making a mistake of mounting positions of right and left of the rotary dampers, and as a result, the assembling can be efficiently carried out.

Moreover, without paying any attention to the fitting directions of the rotary dampers, entirely similar damping effects can be demonstrated whereby at the time of the assembling, workers can assemble without paying attention to the direction of assembling the rotary damperss and can improve the efficiency of the assembling.

### DESCRIPTION OF DRAWINGS

FIG. 1 denotes a cross section showing an embodiment of the present invention.

FIG. 2 denotes an explanatory drawing of an appearance of rotary damper.

FIG. 3 denotes an explanatory drawing of operation of the rotary damper.

FIG. 4 denotes a cross section showing another embodiment of the present invention.

FIG. 5 denotes a cross section of the conventional technologies.

### DETAILED DESCRIPTION OF THE INVENTION

The present invention will be described in details by referring to the attached drawings showing its embodiments in the following.

In FIG. 1, reference numeral 18 denotes a proper member, and is composed of a proper such as Western style stool or piano and a variety of storage boxes with lid or cover. Hinges 22, 24 consisting of projecting members are provided at a portion to which an opening and closing member 20 such as stool seat or stool lid of the proper member 18 or the lid of the piano is attached at a predetermined interval.

The hinges 22, 24 are two pieces in this embodiment, but are not limited particularly to two pieces, and more than two pieces may be provided. Hinges 26, 28 are formed on the opening and closing member 20 in correspondence to the hinges 22, 24 at the proper member side. The hinges 26, 28 at the side of the opening and closing member 20 are disposed adjacent to S1, S2 at the left sides of the hinges 22, 24 at the side of the corresponding proper member 18 as shown in FIG. 1.

For reference, as another embodiment, the hinges 26, 28 at the side of the opening and closing member may be arranged adjacent to the right side of the hinges 22, 24 at the side of the corresponding proper member. Housing storing portions 34, 36 and 38, 40 that store a cylindrical housing 30a of a rotary damper 30 are bored at a pair of the hinges 22, 26 and the hinges 24, 28 which are adjacent and opposed to each other on the respective identical axis.

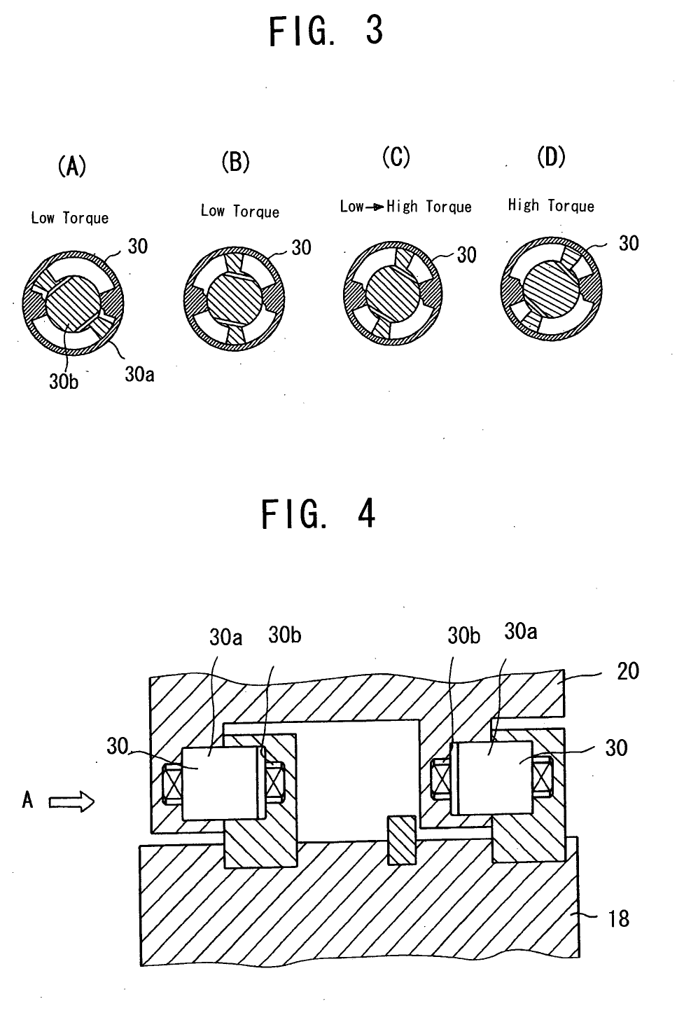

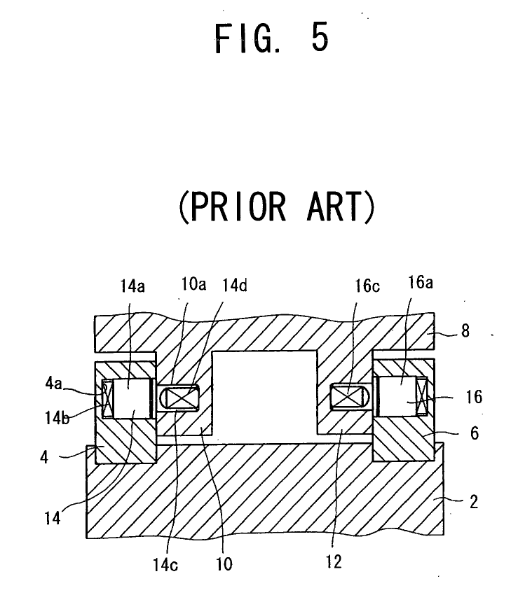

Furthermore, the damper mounting portions 22a, 26a and damper mounting portions 24a, 28a of mutually identical shapes with rotation skid faces are bored on the hinges 22, 26 and the hinges 24, 28 on the respective identical axis. The damper mounting portions 22 a, 24a are opened to one sides S1, S2 of the hinges 22, 24, and the damper mounting portions 26a, 28a are opened to one sides S3, S4 of the hinges 26, 28, and the rotary damper 30 is mounted from these open sides. The rotary damper 30 is composed of a housing 30a of cylindrical type is filled with oil, and a rotary member 30b that fits rotatably to the housing at its part, and in this embodiment, an asymmetrical type that outputs different damping characteristics by the rotating direction of a structure illustrated in FIG. 3 is used. The asymmetrical type rotary damper has damping power that works on the load by a relative rotating direction of the rotary member 30b against the housing 30a. The asymmetrical type rotary damper 30 as shown in FIG. 3 has torque working on the rotary member 30a that change from low torque, low torque, and from low torque to high torque, high torque sequentially as shown in FIG. 3 (A) (B) (C) (D) when the rotary member 30b makes a relative rotation from the condition of the initial position (A) in the clockwise direction against the housing 30a.

When the rotary member 30b relatively rotates in the counter clockwise direction against the housing 30a from the high torque (D), the torque working on the rotary member 30b sequentially changes to the high torque, from the high torque to the low torque, and to the low torque. The internal structure of the asymmetric type rotary damper as shown in FIG. 3 is disclosed in the official gazette of Japanese patent laid open publication (TOKKAI) 2001-349364, and is hitherto open to the public, and moreover, the present invention is not particuarly limited to the rotary damper of the internal structure as shown in FIG. 3 so that its detailed description is omitted.

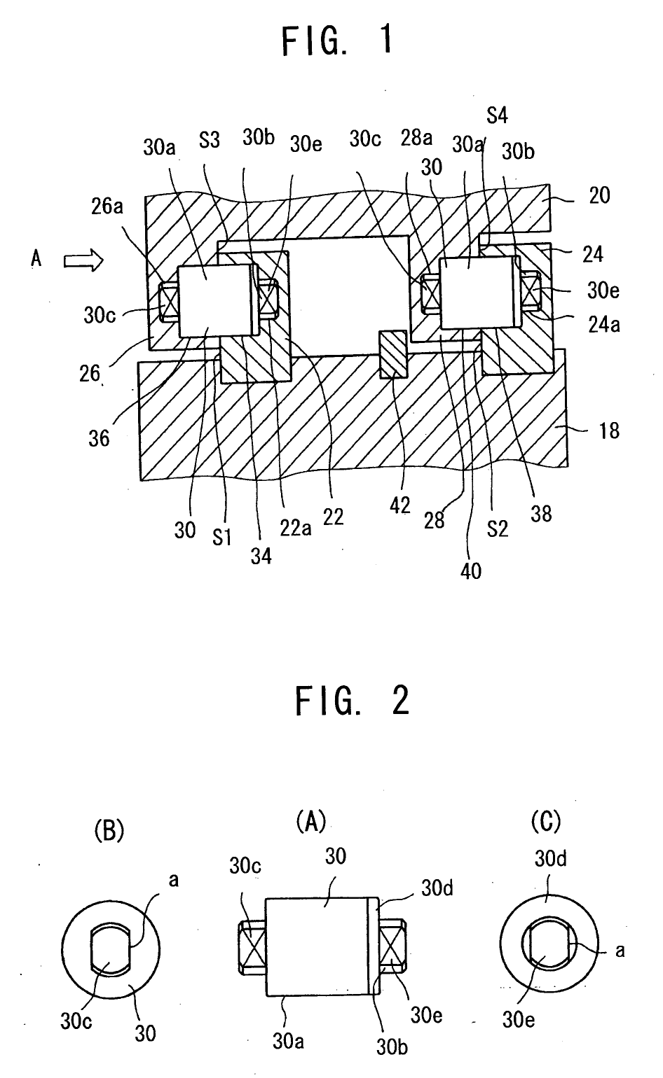

In the central part of the bottom portion of a part of the housing 30 is bored to form a mounting portion 30c having an axial rotation skid face a on the identical axis with the housing 30a. A viscosity fluid for exhibiting the damping power is filled din the housing 30a. The numeral 30d denotes a cap for the housing 30a. A mounting portion 30e of identical shape with the mounting portion 30c is bored in the rotary member 30b of the rotary damper 30. By this arrangement, the rotary damper 30 is formed in such a way that the mounting portions 30c, 30e at both end sides of right and left in an axial direction in FIG. 2 form a bilateral symmetry. Each housing 30a of the rotary dampers 30, 30 is rotatably fitted and disposed on the housing storing portions 34, 36, 38 and 40, and each mounting portion 30c and 30e are fitted and disposed on the corresponding mounting portions 26a, 22a and 28a 24a and are tied to them. Numeral 42 denotes a stopper, and is provided on the proper member 18, and the opening and closing member 20 is arranged not be pulled out in the left side direction in FIG. 1.

In the foregoing construction, when the lid portion (illustration omitted) of the opening and closing member 20 is swivelled in rising direction from the condition where the lid extending to the this side in the perpendicular direction of the paper surface in FIG. 1, the opening and closing member 20 rotates in the anticlockwise direction with the hinges 22, 24 as a fulcrum when it being seen in the arrow mark direction A. At this time, the housing 30a of the rotary damper 30 of the left side rotates in the anticlockwise direction relative to rotary member 30b. Similarly, the housing 30a of the rotary damper 30 rotates in the anticlockwise direction relative to rotary member 30b. Namely, the rotating directions of the rotary dampers of the right side and left side become an identical one.

For this reason, an asymmetric type rotary damper of one kind can be used for the right side and left side of the hinges of the opening and closing member. The rotary dampers of right left as shown in FIG. 1 respectively mounted at the hinge in the mutually identical direction with the mounting portion 30c at the right side but the direction of the rotary damper 30 may be optional.

FIG. 4 shows an arrangement wherein the direction of the rotary damper 30 at right side is disposed inversely to the direction of the axial direction of the rotary damper 30 at the left side but even in this case, when the opening and closing member 20 is swivelled in the rising direction from the condition where the opening member 20 is similarly closed, the rotary member 30 of the rotary damper 30 at the right side rotates in the anticlockwise direction when it being viewed in the arrow mark direction A, and when it being viewed as the housing 30a as a standard, the housing 30a rotates in the anticlockwise direction relatively against the rotary member 30b, and as a result, the rotating directions of the rotary dampers of right and left side become identical.

Accordingly, the rotary dampers 30, 30 can be mounted between the hinge members 22 and 26 and between the hinge members 24 and 28 in an optional direction. The asymmetric type rotary dampers to be used in this invention are such as the rotary damper disclosed in the Japanese official gazette of publicly known TOKKAI H-282039 or other types such as the rotary dampers of a structure with different torque characteristics depending on the rotating direction.

Furthermore, the present invention is characterized in that the mounting member 30c and 30e are formed in a identical shape as shown in FIG. 2, and the rotary damper 30 is particulaly not limited to the embodiment of a bilateral symmetry. The mounting member 30c and 30e are of different shape, and the mounting member 26a and 28a at the side of the proper member 20 are formed to be suitable for the shape of the mounting member 30c, and the mounting member 22a and 24a at the side of the proper member 18 may be formed as a structure suitable to the shape of the mounting member 30e.

Furthermore, as a its reversal structure, the mounting members 30c and 30e are formed in a different shape, and the mounting members 22a and 24a at the side of the proper member 18 are formed in a differnt shape, and the mounting members 26a, 28a at the side of the opening and closing member 20 may be formed in a structure suitable to the shape of the mounting member 30e. Furthermore, the mounting member 30c may be shaped to a shape suitable to any of the mounting members 22a, 24a, 26a, 28a and if the mounting member 30e is shaped to a shape suitable to any of the mounting member 22a, 24a, 26a, 28a, the same operation and effect identical with the case of using the rotary damper 30 wherein the mounting member 30c and the mounting member 30e as shown in FIG. 2 are identical are used can be obtained althogh the mounting member 30c and the mounting member 30e are not necessarily of identical shape. Furthermore, in this case, the mounting member 30c and the mounting member 30e of mutually differnt shapes may be made suitable to any of the mounting members 22a, 24a, 26a 28a with the use of the adapters and like.

What is claimed is:

1. An opening and closing mechanism with damper wherein at least two pieces of hinge members 22, 24 are provided at the proper member 18 side at a predetermined interval and at least two pieces of hinge members 26, 28 are provided at the opening and closing member 20 side in correspondence to the each hinge members 22, 24, and hinge members 26, 28 corresponding to the opening and closing member 20 side are disposed in opposition to one side S1 of one hinge member 22 among the hinge members 22, 23 at the proper member 18 side and to the one side S2 at the side same with the one side S1 of the one one hinge member 22 of the other hinge member 24, and mounting members 22a, 24a for the rotary damper opened to the each of one side of the one direction side are provided on each hinge members 22, 24, and mounting members 26a, 28a for rotary damper opened to each one side S3, S4 of the side facing each hinge member 22, 24 at the proper member 18 side are provided on each hinge member 26, 28 of the opening and closing member 20 side, and a rotary damper 30 having mounting members 30c, 30e at both end sides which has the damping power of asymmetric type is disposed between hinge members opposed to each other, and the mounting member 30e at one side of the rotary damper 30 is tied to the mounting members 22a, 24a provided on the hinge members 22, 24 of the proper member 18, and the mounting member 30c at the other side of the rotary damper 30 is tied to the mounting members 26a, 28a provided on the hinge members 26, 28 at the side of the opening and closing member 20, and the opening and closing member 20 is swivellably journalled on the proper member 18 with the rotary damper 30 as a center of rotation, and the damping power of the rotary damper 30 is provided against the swivelling motion of the opening and closing member 20 with the rotary damper 30 as a center of rotation.

2. An opening and closing mechanism with damper according to claim 1 wherein the rotary damper 30 is composed of a cylindrical housing 30a and a rotary member 30b whose part is rotatably housed in the housing 30 and is relatively rotatable to the housing member 30 a, and the mounting member 30c at one end side among the mounting members mounted at both end sides of the rotary damper is formed at an end portion of the housing 30a, and the mounting member 30e at the other end side is formed at the end of the rotary member 30b, and the shape of the mounting member 30c at one end side of the rotary damper 30 and the mounting member 30e at the other end side is arranged to be symmetric shape.

3. An opening and closing mechanism with damper according to the claim 1 wherein the mounting member 30c at one end side of the rotary damper 30 is shaped suitable to any of the mounting members 26a, 28a at the side of the opening and closing member and the mounting member 22a, 24a at the side of the proper member 18, and the mounting member 30e at the other end side of the rotary damper 30 is shaped suitable to any of the mounting member 26a, 28a at the side of the opening and closing member 20 and the mounting member 22a, 24a at the side of the proper member 18.
